(19) United States
(12) Patent Application Publication
(10) Pub. No.: US 2014/0079339 A1
(43) Pub. Date: Mar. 20, 2014

(54) SYSTEM AND METHOD FOR ZOOMING DIFFERENT REGIONS IN IMAGE AT DIFFERENT SCALES

(71) Applicants: INVENTEC (PUDONG) TECHNOLOGY CORPORATION, Shanghai (CN); INVENTEC CORPORATION, Taipei (TW)

(72) Inventors: Sean LIU, Shanghai (CN); Qingsong WANG, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/803,480

(22) Filed: Mar. 14, 2013

(30) Foreign Application Priority Data
Sep. 18, 2012 (CN) 201210349548.8

(51) Int. Cl. G06T 3/40

(52) U.S. Cl. CPC G06T 3/40
USPC 382/298

(57) ABSTRACT

A system and a method for zooming different regions in an image at different scales are provided. Through a technical means of determining a valid region and an invalid region in an original image, and respectively zooming the valid region and the invalid region at different scales, a technical efficacy of relieving a distortion condition in the valid region in the original image and enabling a user to fully understand a message indicated in the image can be achieved.

### BACKGROUND OF THE INVENTION

1. Field of the Invention

The present invention relates to an image zooming system and method, and more particularly to a system and a method for zooming different regions in an image at different scales.

2. Description of Related Art

The development of image zooming technologies of pictures becomes mature. Therefore, currently, when various devices with a display function display data, for example, display web pages or articles in which text keeps abreast with graphs, if the displayed data includes an image in a picture form, to provide a desirable visual effect to a user so that the user can conveniently read the data, the various devices generally first zoom the image included in the displayed data, and then display the zoomed image.

However, when zooming images, the devices zoom the whole image by using one single scale. However, through the current image zooming technologies, image distortion is generally caused, resulting in that the zoomed image is not clear enough; moreover, the greater the scale is, the severer the image distortion condition after zooming is, that is, the greater the scale is, the fuzzier the zoomed image is. Therefore, if the devices use too large scale when zooming the image or a region including an indicated message in the image is too small, after the image is zoomed, due to the severe distortion condition, the message indicated in the image is fuzzy and cannot be read by the user.

To sum up, it can be known that in the prior art, a problem that the zoomed image is probably too fuzzy for the user to read exists for a long time, so it is necessary to propose an improved technical means to solve this problem.

### SUMMARY OF THE INVENTION

In view of the problem in the prior art that some zoomed images are too fuzzy, the present invention discloses a system and a method for zooming different regions in an image at different scales.

The system for zooming different regions in an image at different scales disclosed by the present invention at least includes: an image loading module, used for loading a pre-stored original image; a region determination module, used for determining a valid region and an invalid region in the original image; a region zooming module, used for zooming the valid region at a first scale and zooming the invalid region at a second scale; an image combination module, used for combining the zoomed valid region and the zoomed invalid region into a zoomed image; and an image output module, used for outputting the zoomed image.

The method for zooming different regions in an image at different scales at least includes the following steps: loading a pre-stored original image; determining a valid region and an invalid region in the original image; zooming the valid region at a first zooming scale and zooming the invalid region at a second zooming scale; combining the zoomed valid region and the zoomed invalid region into a zoomed image; and outputting the zoomed image.

The system and the method disclosed by the present invention are described above. The difference between the present invention and the prior art lies in that, in the present invention, a valid region and an invalid region in an original image are determined, and the valid region and the invalid region are respectively zoomed at different scales, so as to solve the problem in the prior art, thereby achieving a technical efficacy of relieving a distortion condition in the valid region in the original image and enabling the user to fully understand a message indicated in the image.

### BRIEF DESCRIPTION OF THE DRAWINGS

The invention will become more fully understood from the detailed description given herein below illustration only, and thus is not limitative of the present invention, and wherein:

FIG. 1 is an architecture diagram of a system for zooming different regions in an image at different scales according to the present invention.

FIG. 2 is a flow chart of a method for zooming different regions in an image at different scales according to the present invention.

FIG. 3A is a schematic diagram of an original image according to an embodiment of the present invention.

FIG. 3B is a schematic diagram of a valid region and an invalid region according to an embodiment of the present invention.

FIG. 3C is a schematic diagram of zooming an image according to an embodiment of the present invention.

FIG. 3D is a schematic diagram of an original image according to an embodiment of the present invention.

FIG. 3E is a schematic diagram of a valid region and an invalid region according to an embodiment of the present invention.

FIG. 3F is a schematic diagram of zooming an image according to an embodiment of the present invention.

FIG. 4A is a schematic diagram of an original image according to an embodiment of the present invention.

FIG. 4B is a schematic diagram of valid regions and an invalid region according to an embodiment of the present invention.

FIG. 4C is a schematic diagram of a zoomed image according to an embodiment of the present invention.

### DESCRIPTION OF THE EMBODIMENTS

The present invention will be apparent from the following detailed description, which proceeds with reference to the accompanying drawings, wherein the same references relate to the same elements.

In the present invention, when an image is zoomed, a valid region and an invalid region in the image are zoomed at different scales, so as to relieve a fuzz condition of the valid region in the image after the image is zoomed, and avoid a case of unidentifiable content.

The valid region mentioned in the present invention refers to a region including a message to be expressed that is recorded in the image, and includes but is not limited to a region including text or patterns in the image. The invalid region mentioned in the present invention refers to other region than the valid region, for example, a blank region or a region including few patterns in the image, but the present invention is not limited thereto.

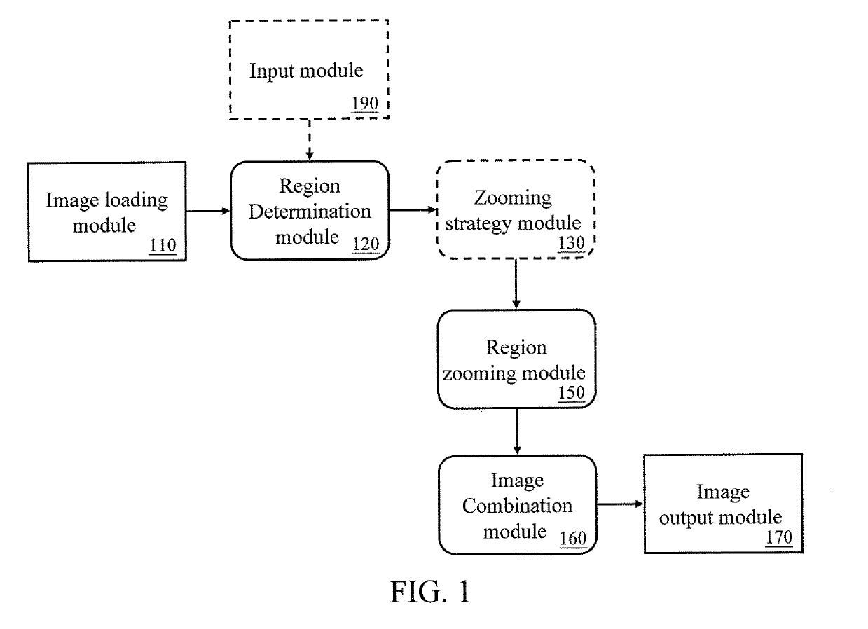

FIG. 1 is an architecture diagram of a system for zooming different regions in an image at different scales according to the present invention. First, with reference to FIG. 1, an operation of the system in the present invention is described. As shown in FIG. 1, the system of the present invention includes an image loading module 110, a region determination module 120, a region zooming module 150, an image combination module 160, and an image output module 170.

The image loading module 110 is used for loading an image to be zoomed, where the image loaded by the image loading module 110 is referred to as an “original image” in the present invention. The original image is pre-stored in a storage medium inside a device for executing the present invention, or is pre-stored in another device out of the device for executing the present invention, which is not particularly limited in the present invention. If the original image is stored in another device out of the device for executing the present invention, the image loading module 110 downloads the original image through a network protocol such as a Hyper Text Transport Protocol (HTTP) or a File Transfer Protocol (FTP), or through a transmission protocol such as a Universal Serial Bus (USB) or RS-232, but the protocol adopted by the image loading module 110 to load the original image is not limited thereto.

The region determination module 120 is used for determining a valid region and an invalid region in the original image loaded by the image loading module 110. In one original image, the region determination module 120 may determine one or more valid regions, and may also determine one or more invalid regions.

The region determination module 120 may detect a blank part in the original image, so as to determine the invalid region and the valid region in the original image. For example, the image determination module 120 may directly determine the blank part in the original image as the invalid region, or determine a blank part with a proportion or an area exceeding a predetermined value in the original image as the invalid region; and then determine the other part than the invalid region as the valid region. The image determination module 120 may also judge the valid region and the invalid region according to a pixel color of the original image. For example, the region determination module 120 may judge, according to the number or complexity of the pixel color in a unit region of the original image, whether the unit region is a valid region or an invalid region; and when the number of the pixel colors in the unit region is more than a certain number, the pixel colors of two adjacent pixels are obviously different from each other, or the number of times the pixel color is changed in a vertical direction, a horizontal direction, or any other directions reaches a certain value, the region determination module 120 may determine that the unit region is a valid region, otherwise, determine that the unit region is an invalid region. The region determination module 120 may also define the valid region and the invalid region according to an input signal. That is to say, the region determination module 120 may directly perform, through an input module 190, frame-selection on the original image to obtain one or more regions, and define the frame-selected region as the valid region and the region not being frame-selected as the invalid region. However, the manner of the region determination module 120 determining the valid region and the invalid region is not limited to the foregoing description.

In some embodiments, the region determination module 120 may further record position information of each valid region and/or each invalid region in the original image. The position information recorded by the region determination module 120 may indicate data of a position of the valid region/invalid region in the original image, for example, a coordinate of an upper-left corner of the valid region/invalid region in the original image, but the present invention is not limited thereto.

The region zooming module 150 is used for zooming, at a first scale, the valid region determined by the region determination module 120, and zooming, at a second scale, the invalid region determined by the region determination module 120. When there are multiple valid regions or invalid regions determined by the region determination module 120, the region zooming module 150 generally zooms all valid regions by using the same first scale, and zooms all invalid regions by using the same second scale, but the present invention is not limited thereto. In some embodiments, the region zooming module 150 may also zoom the valid regions by using different first scales and/or zoom the invalid regions by using different second scales.

Generally speaking, the first scale used by the region zooming module 150 to zoom the valid region is different from the second scale used to zoom the invalid region. There is no special restriction in the present invention, and the first scale is generally greater than or equal to the second scale. In some embodiments, the second scale may even be zero (that is, the invalid region is deleted). It should be noted that, the first scale and the second scale may be a pre-determined value, but in some embodiments, the first scale and the second scale may also be obtained through calculation by a zooming strategy module 130, where the zooming strategy module 130 is described later.

The image combination module 160 is used for combining the valid region zoomed by the region zooming module 150 and the invalid region zoomed by the region zooming module 150 into a new image. In the present invention, the new image combined by the image combination module 160 is referred to as a “zoomed image”.

Generally speaking, the image combination module 160 may judge, according to the position information of the valid region and the invalid region in the original image that is recorded by the region determination module 120, relative positions of the valid region and the invalid region in the original image, so as to combine the zoomed valid region and the zoomed invalid region. For example, when the valid region is at an upper side/right side of the original image, and the invalid region is at a lower side/left side of the original image, the image combination module 160 also sets the zoomed valid region at the upper side/left side of the zoomed invalid region.

The image output module 170 is used for outputting the zoomed image combined by the image combination module 160. The image output module 170 may display the zoomed image, and store the zoomed image in a storage medium inside a device for executing the present invention or store the zoomed image in another device out of the device for executing the present invention, so as to output the zoomed image. However, the manner of the image output module 170 outputting the zoomed image is not limited to the foregoing description, and any output manner enabling the zoomed image to be subsequently and continuously used can all be used in the present invention.

The present invention may further include an addable zooming strategy module 130, used for developing a zooming strategy according to a position of the valid region determined by the region determination module 120 in the original image loaded by the image loading module 110 and/or a proportion of the invalid region determined by the region determination module 120 in the original image loaded by the image loading module 110, The zooming strategy developed by the zooming strategy module 130 at least includes the first scale and the second scale used by the region zooming module 150.

In some embodiments, for example, when the valid region is at the upper side of the original image, the zooming strategy module 130 may calculate the first scale and the second scale according to a proportion of a length of the original image to a length (referred to as a “target length” in the following) required by the zoomed image so that the length of the zoomed image combined by the image combination module 160 conforms to the target length. Still for example, when the valid region is at the right side of the original image, the zooming strategy module 130 may calculate the first scale and the second scale according to a proportion of a width of the original image to a width (referred to as a “target width” in the following) required by the zoomed image, so that the width of the zoomed image combined by the image combination module 160 conforms to the target width. Likewise, the zooming strategy module 130 may also calculate the first scale and the second scale according to the proportion of the length of the original image to the target length together with the proportion of the width of the original image to the target width. For example, the zooming strategy module 130 calculates the first scale and the second scale according to a smaller one of the proportion of the length of the original image to the target length and the proportion of the width of the original image to the target width, such as according to 60%, in two proportions 60% and 66%, so that the length/width of the zoomed image combined by the image combination module 160 conforms to the target length/width, where for a greater one of the proportion of the length of the original image to the target length and the proportion of the width of the original image to the target width, the length/width after zooming is smaller than the target length/width.

In some embodiments, the zooming strategy module 130 may also develop the first scale and the second scale according to the proportion of the length of the valid region to the target length, the proportion of the width of the valid region to the target width, the proportion of the length of the valid region to the target length together with the proportion of the width of the valid region to the target width, or a proportion of an area of the valid region in the original image, For example, the zooming strategy module 130 develops that the first scale is 60% and the second scale is 0% (that is, the invalid region is deleted, so that the zoomed image does not include the invalid region), or determines that the first scale is 75% and the second scale is 25%, but the present invention is not limited thereto.

In addition, since the region determination module 120 probably determines multiple valid regions and/or invalid regions, the zooming strategy module 130 may further develop a different first scale for each valid region; similarly, the zooming strategy module 130 may also develop a different second scale for each invalid region.

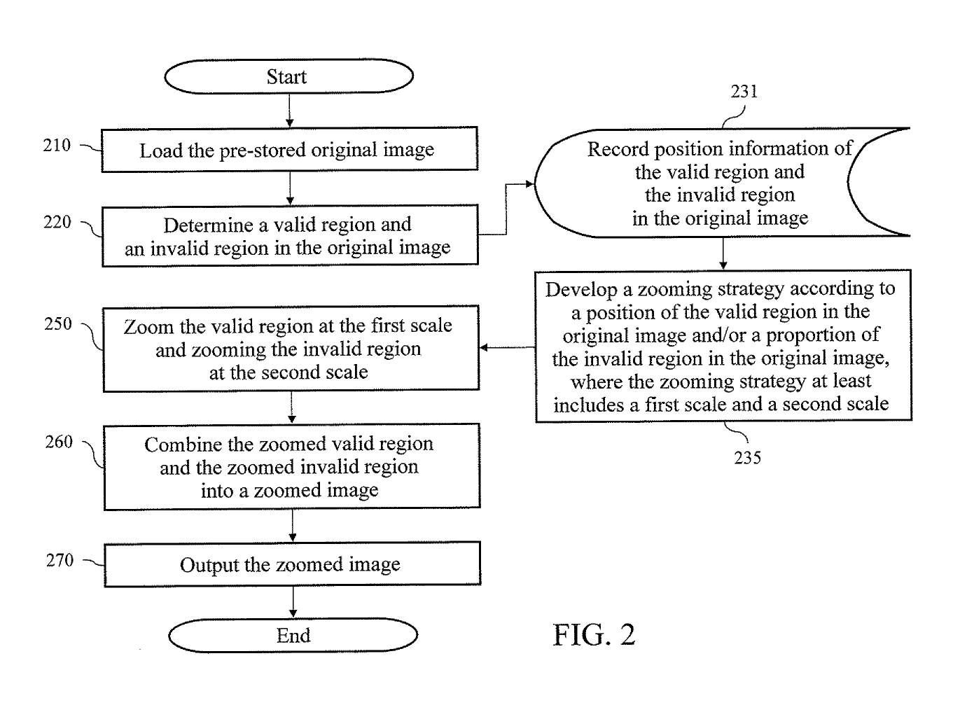

Then, with reference to a first embodiment, an operating system and method of the present invention are illustrated. Referring to FIG. 2, a flow chart of a method for zooming different regions in an image at different scales according to the present invention is shown.

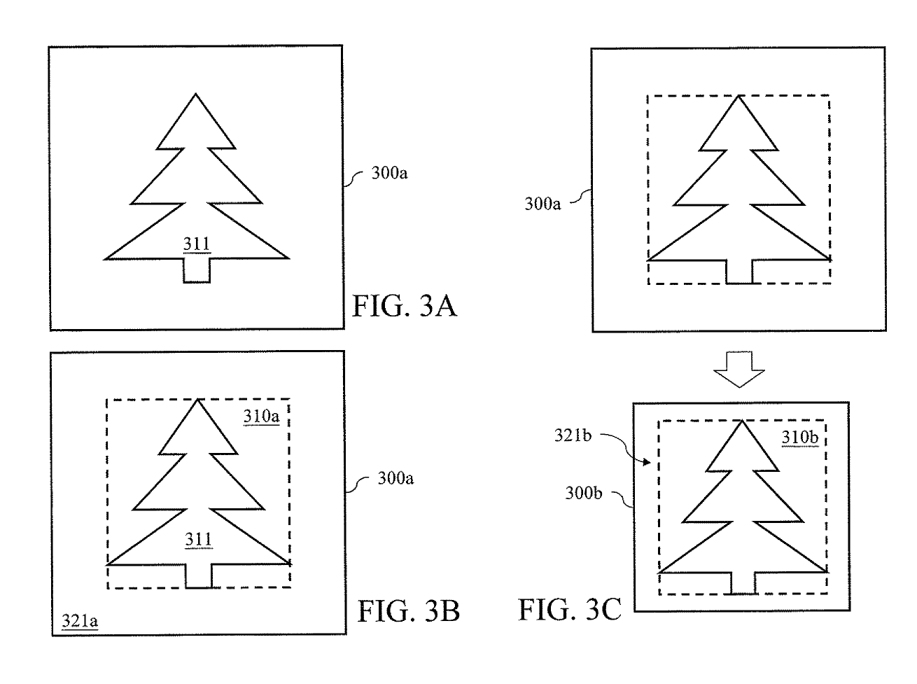

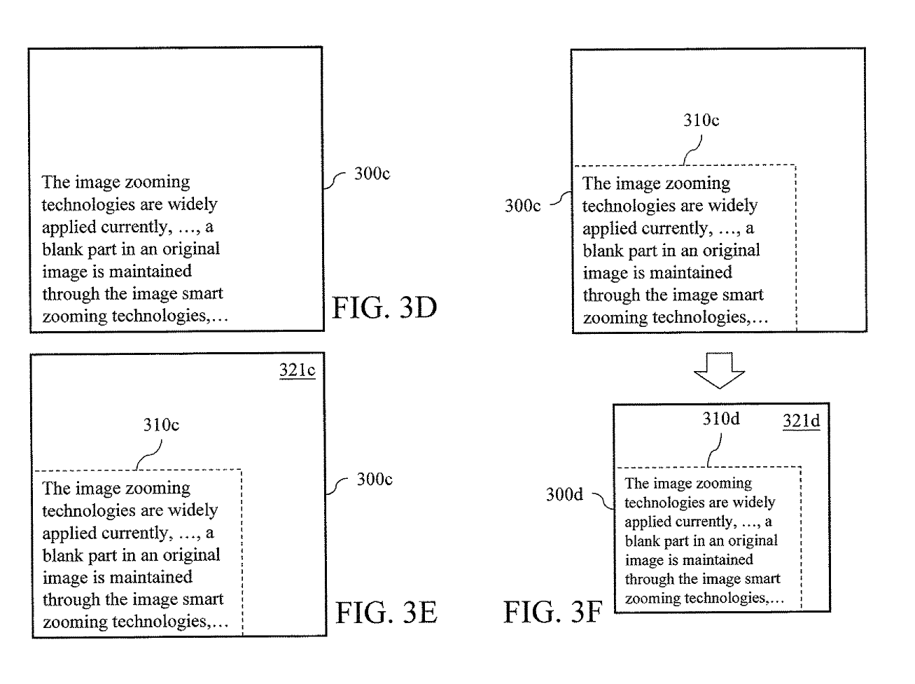

In the present invention, when an original image is about to be zoomed, the image loading module 110 may load the pre-stored original image (Step 210). In this embodiment, if the image loading module 110 downloads an original image 300a shown in FIG. 3A from a network to a server, the original image 300a downloaded by the image loading module 110 mainly shows a tree 311.

After the image loading module 110 loads the pre-stored original image (Step 210), the region determination module 120 may determine a valid region and an invalid region in the original image loaded by the image loading module 110 (Step 220). In this embodiment, it is supposed that the region determination module 120 will detect a blank part in the original image 300a. As shown in FIG. 3B, after detecting the blank part in the original image 300a, the region determination module 120 determines an invalid region 321a, and determines that other region than the invalid region 321a in the original image 300a is a valid region 310a; similarly, the region determination module 120 may also judge, according to a pixel color of the tree 311 and a pixel color of a background in the original image 300a, the valid region 310a, and further judge that other region than the valid region 310a in the original image 300a is the invalid region 321a.

After the region determination module 120 determines the valid region and the invalid region in the original image (Step 220), the region zooming module 150 may zoom the valid region determined by the region determination module 120 at a first scale, and zoom the invalid region determined by the region determination module 120 at a second scale (Step 250). In this embodiment, it is supposed that the region zooming module 150 zooms the valid region 310a in the original image 300a by using a predetermined first scale, such as 77%, and zooms the invalid region 321a in the original image 300a by using a predetermined second scale, such as, 28%.

In this embodiment, if a zooming strategy module 130 is further included, before the region zooming module 150 zooms the valid region at the first scale and zooms the invalid region at the second scale (Step 250), the zooming strategy module 130 may develop a zooming strategy at least including a first scale and a second scale according to a position of the valid region determined by the region determination module 120 in the original image loaded by the image loading module 110 and/or a proportion of the invalid region determined by the region determination module 120 to the original image loaded by the image loading module 110 (Step 235). It is supposed that, the zooming strategy module 130 first calculates a proportion of the invalid region 321a (or the valid region 310a) in the original image 300a, and develops the first scale and the second scale according to the proportion obtained through calculation, for example, develops the first scale and the second scale according to a grade step of the proportion obtained through calculation. If the zooming strategy module 130 develops that the first scale and the second scale are respectively 77% and 28%, the region zooming module 150 may zoom the valid region and the invalid region respectively through the first scale and the second scale that are obtained through calculation performed by the zooming strategy module 130 (Step 250).

After the region zooming module 150 zooms the valid region at the first scale and zooms the invalid region at the second scale (Step 250), the image combination module 160 may combine the valid region zoomed by the region zooming module 150 and the invalid region zoomed by the region zooming module 150 into a zoomed image (Step 260), and then the image output module 170 may output the zoomed image. In this embodiment, as shown in FIG. 3C, in the zoomed image 300b combined by the image combination module 160, a scale of reduction of the zoomed valid region 310b is smaller than a scale of reduction of the zoomed invalid region 321b, that is, the proportion of the zoomed valid region 310b in the zoomed image 300b is greater than the proportion of the zoomed invalid region 321b in the zoomed image 300b. Therefore, compared with the prior art in which the whole original image is zoomed at a single scale, in the present invention, the valid region 310b accounts for a greater proportion in the zoomed image. As a result, in the case of a zoomed image of the same size, the valid region 310b in the zoomed image of the present invention is clearer than a valid region in the zoomed image in the prior art.

With reference to a second embodiment, an operating system and method of the present invention are illustrated below. Refer to FIG. 2. In the present invention, when an original image is about to be zoomed, the image loading module 110 may load the pre-stored original image (Step 210). In this embodiment, it is supposed that, the image loading module 110 loads an original image 300c shown in FIG. 3D from a storage medium in a device for executing the present invention, and the original image 300c mainly shows a section of text.

After the image loading module 110 loads the pre-stored original image (Step 210), the region determination module 120 may determine a valid region and an invalid region in the original image (Step 220). In this embodiment, it is supposed that the region determination module 120 will detect a blank part in the original image 300c. As shown in FIG. 3E, after detecting the blank part in the original image 300c, the region determination module 120 determines an invalid region 321c, and determines that other region than the invalid region 321c in the original image 300c is a valid region 310c; similarly, the region determination module 120 may also judge, according to the case that a pixel color of the original image 300c ceaselessly changes between black and white, the valid region 310c, and further judge that other region than the valid region 310c in the original image 300c is the invalid region 321c.

After the region determination module 120 determines the valid region and the invalid region in the original image (Step 220), the region zooming module 150 may zoom the valid region at a first scale, and zoom the invalid region at a second scale (Step 250). In this embodiment, it is supposed that, the region zooming module 150 zooms the valid region 310c and the invalid region 321c in the original image 300c respectively by using the first scale and the second scale that are developed by the zooming strategy module 130.

Therefore, before the region zooming module 150 zooms the valid region at the first scale and zooms the invalid region at the second scale (Step 250), the zooming strategy module 130 may develop a zooming strategy at least including the first scale and the second scale according to a position of the valid region in the original image and/or a proportion of the invalid region in the original image (Step 235).

In this embodiment, it is supposed that, the zooming strategy module 130 first calculates a proportion of the invalid region 321c (or the valid region 310c) in the original image 300c, and when the proportion of the invalid region 321c in the original image 300c is greater than or equal to a predetermined value such as 50%, develops the first scale and the second scale in a manner described in the first embodiment. When the proportion of the invalid region 321c in the original image 300c is smaller than a predetermined value, the zooming strategy module 130 calculates the first scale and the second scale according to a position of the valid region 310c in the original image 300c When the valid region 310c is at a left/right side of the original image 300c, the zooming strategy module 130 calculates the first scale and the second scale according to a proportion of a width of the original image 300c to a target width; when the valid region 310c is at an upper/lower side of the original image 300c, the zooming strategy module 130 calculates the first scale and the second scale according to a proportion of a length of the original image 300c to a target length; and when the valid region 310c is at a center of the original image 300c, the zooming strategy module 130 calculates the first scale and the second scale in a manner described in the first embodiment. Therefore, as shown in FIG. 3E, the valid region 310c is at a lower-left side of the original image 300c; in this case, the zooming strategy module 130 calculates the first scale and the second scale according to the proportion of the length of the original image 300c to the target length together with the proportion of the width of the original image 300c to the target width, so as to maintain positions of the zoomed valid region and the zoomed invalid region in the combined image.

In this way, after the zooming strategy module 130 develops the zooming strategy at least including the first scale and the second scale according to a position of the valid region in the original image and/or a proportion of the invalid region in the original image (Step 235), the region zooming module 150 may zoom the valid region at the first scale and zoom the invalid region at the second scale (Step 250), the image combination module 160 may combine the zoomed valid region and the zoomed invalid region into the zoomed image (Step 260), and then the image output module 170 may output the zoomed image. In this embodiment, as shown in FIG. 3F, in the zoomed image 300d combined by the image combination module 160, a scale of reduction of the zoomed valid region 310d is smaller than a scale of reduction of the zoomed invalid region 321d. That is to say, the proportion of the valid region 310d in the zoomed image of the present invention is greater than the proportion of the valid region in the zoomed image produced by zooming the original image at a single scale in the prior art, so the valid region 310d in the zoomed image of the present invention is clearer than the valid region in the zoomed image in the prior art.

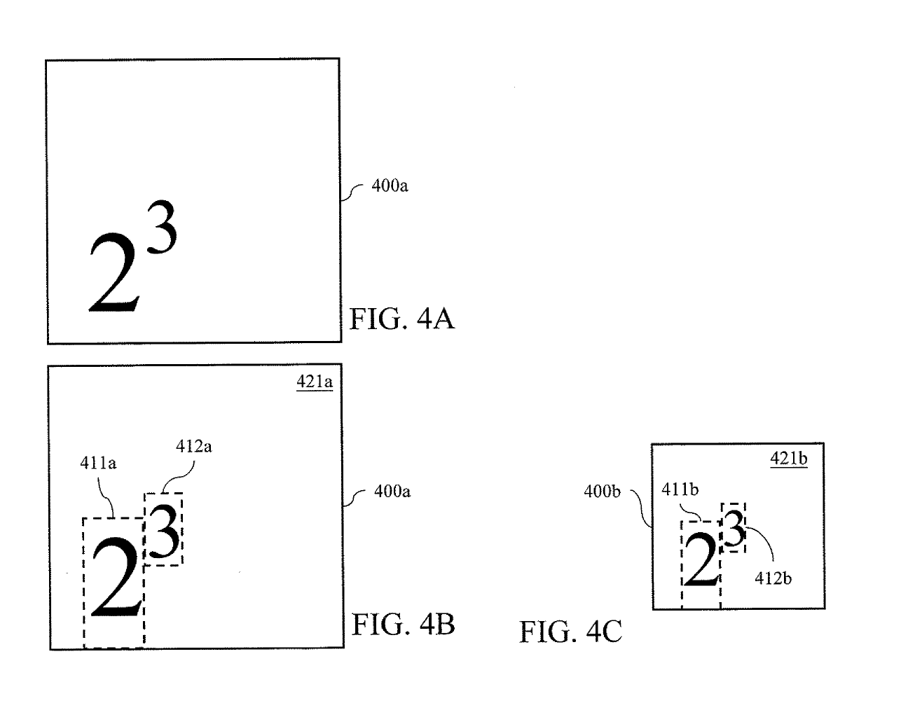

With reference to a third embodiment, an operating system and method of the present invention are illustrated below. Refer to FIG. 2 continuously. In the present invention, when an original image is about to be zoomed, the image loading module 110 may load the pre-stored original image (Step 210). In this embodiment, it is supposed that, the image loading module 110 loads an original image 400c shown in FIG. 4A from a storage medium in a device for executing the present invention, and the original image 400c mainly shows a mathematical symbol 2³.

After the image loading module 110 loads the pre-stored original image (Step 210), the region determination module 120 may determine a valid region and an invalid region in the original image (Step 220). In this embodiment, it is supposed that, the region determination module 120 judges, according to the case that a pixel color of the original image 400a changes between black (the mathematical symbol) and white (the background), the valid regions 411a and 412a, and judges that the other region than the valid regions 411a and 412a in the original image 400a is the invalid region 421a, as shown in FIG. 4B.

After determining the valid region and the invalid region in the original image (Step 220), the region determination module 120 may record position information of the determined valid region and invalid region in the original image (Step 231). Afterwards, the zooming strategy module 130 may develop a zooming strategy at least including a first scale and a second scale according to the recorded position information of the valid region in the original image and/or a proportion of the invalid region in the original image (Step 235).

In this embodiment, since the region determination module 120 determines two valid regions, the zooming strategy module 130 first judges whether to zoom the valid regions 411a and 412a by using the same first scale. The zooming strategy module 130 can judge whether the size of the valid regions 411a and 412a are meaningful or not. If the relative size of the valid regions 411a and 412a should keep a certain proportion, the zooming strategy module 130 will judge the size of the valid regions 411a and 412a are meaningful, and judges that keeping the relative size of the valid regions 411a and 412a is needed. Thus, the zooming strategy module 130 will use the same first scale to zoom the valid regions 411a and 412a. For example, it is meaningful that the numbers 2 and 3 in the mathematical symbol 2³ shown by the original image 400a of the present invention are of different sizes, so that the zooming strategy module 130 judges that the first scale used to zoom the valid regions 411a and 412a should be the same, so as to avoid that the size of the valid region 411a is the same as that of the valid region 412a after the zooming, and prevent the mathematical symbol 2³ shown by the original image 400a from being mistaken for a number 23. However, if the size of the valid regions 411a and 412a is meaningless, the zooming strategy module 130 may respectively zoom the valid regions 411a and 412a by using different first scales.

After the zooming strategy module 130 judges whether to zoom the valid regions 411a and 412a by using the same first scale, the zooming strategy module 130 develops the first scale and the second scale in a manner described in the second embodiments.

After the zooming strategy module 130 develops the zooming strategy at least including the first scale and the second scale according to the recorded position information of the valid region in the original image and/or the proportion of the invalid region in the original image (Step 235), the region zooming module 150 may zoom the valid regions 411a and 412a at the first scale developed by the zooming strategy module 130, and zoom the invalid region 421a at the second scale (Step 250).

After the region zooming module 150 zooms the valid regions 411a and 412a at the first scale and zooms the invalid region 421a at the second scale (Step 250), the image combination module 160 may combine the zoomed valid region and the zoomed invalid region into a zoomed image (Step 260). In this embodiment, the image combination module 160 sets, according to the position information of the valid regions 411a and 412a in the original image 400a that is recorded by the region determination module 120, the zoomed valid region 412b at an upper right side of the zoomed valid region 411b.

After the image combination module 160 combines the zoomed valid region and the zoomed invalid region into the zoomed image (Step 260), the image output module 170 may output the zoomed image. In this embodiment, as shown in FIG. 4C, in the zoomed image 400b combined by the image combination module 160, a scale of reduction of the zoomed valid regions 411b and 412b is smaller than a scale of reduction of the zoomed invalid region 421b, and the zoomed valid regions 411b and 412b still maintain a pattern of 2³. That is to say, the proportion of the valid regions 411b and 412b in the zoomed image of the present invention is greater than the proportion of the valid regions in the zoomed image produced by zooming the original image at a single scale in the prior art, so the valid regions 411b and 412b in the zoomed image of the present invention is clearer than the valid regions in the zoomed image in the prior art.

To sum up, it can be known that, the difference between the present invention and the prior art lies in that, the present invention adopts a technical means of determining a valid region and an invalid region in an original image, and respectively zooming the valid region and the invalid region at different scales. Through this technical means, the problem in the prior art that a part of image is too fuzzy after being zoomed can be solved, thereby achieving a technical efficacy of relieving a distortion condition in the valid region in the original image and enabling the user to fully understand a message indicated in the image.

Moreover, the method for zooming different regions in an image at different scales according to the present invention may be implemented in hardware, software, or a combination of hardware and software, and may also be implemented in a computer system in a centralized manner or implemented in a decentralized manner where different elements are distributed in several inter-connected computer systems.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for zooming different regions in an image at different scales, at least comprising the following steps:
loading a pre-stored original image;
determining at least one valid region and at least one invalid region in the original image;
zooming the valid region at least at a first scale and zooming the invalid region at least at a second scale; and
combining at least one zoomed valid region and at least one zoomed invalid region into a zoomed image; and
outputting the zoomed image.

2. The method for zooming different regions in an image at different scales according to claim 1, wherein the step of determining the valid region and the invalid region in the original image is detecting a blank part in the original image for determining the blank part is the invalid region and determining the other region in the original image is the valid region, judging the valid region and the invalid region according to pixel color of the original image, or defining the valid region and the invalid region according to an input signal.

3. The method for zooming different regions in an image at different scales according to claim 1, wherein after the step of determining the valid region and the invalid region in the original image, the method further comprises: developing a zooming strategy according to a position of the valid region in the original image and/or a proportion of the invalid region in the original image, wherein the zooming strategy at least comprises the first scale and the second scale.

4. The method for zooming different regions in an image at different scales according to claim 3, wherein the step of developing the zooming strategy further comprises: calculating the first scale and the second scale according to a proportion of a length of the original image to a target length together with a proportion of a width of the original image to a target width, or calculating the first scale and the second scale according to a proportion of a length of the valid region to a target length and a proportion of a width of the valid region to a target width.

5. The method for zooming different regions in an image at different scales according to claim 3, wherein the step of developing the zooming strategy further comprises: judging whether to zoom at least one of the valid region/invalid region by using the same first scale/the same second scale; when it is judged that the same first scale/the same second scale is required to be used, the step of combining the zoomed valid region and the zoomed invalid region into the zoomed image further comprises: setting the zoomed valid region and the zoomed invalid region according to the position of the valid region in the original image.

6. The method for zooming different regions in an image at different scales according to claim 5, wherein the step of judging whether to zoom at least one of the valid region/invalid region by using the same first scale/the same second scale further comprises: judging that keeping relative size of the valid regions is needed, zooming the valid regions by using the same first scale.

7. A system for zooming different regions in an image at different scales, at least comprising:
an image loading module, used for loading a pre-stored original image;
a region determination module, used for determining at least one valid region and at least one invalid region in the original image;
a region zooming module, used for zooming the valid region at least at a first scale, and zooming the invalid region at least at a second scale;
an image combination module, used for combining at least one zoomed valid region and at least one zoomed invalid region into a zoomed image; and
an image output module, used for outputting the zoomed image.

8. The system for zooming different regions in an image at different scales according to claim 7, wherein the region determination module detects a blank part in the original image for determine the blank part is the invalid region and determine the other region in the original image is the valid region, judges the valid region and the invalid region according to pixel color of the original image, or defines the valid region and the invalid region according to an input signal.

9. The system for zooming different regions in an image at different scales according to claim 7, further comprising a zooming strategy module, used for developing a zooming strategy according to a position of the valid region in the original image and/or a proportion of the invalid region in the original image, wherein the zooming strategy at least comprises the first scale and the second scale.

10. The system for zooming different regions in an image at different scales according to claim 9, wherein the zooming strategy module is further used for calculating the first scale and the second scale according to a proportion of a length of the original image to a target length together with a proportion of a width of the original image to a target width and a proportion of a length of the valid region to a target length and a proportion of a width of the valid region to a target width.

11. The system for zooming different regions in an image at different scales according to claim 9, wherein the zooming strategy module is further used for judging whether to zoom at least one of the valid region/invalid region by using the same first scale/the same second scale, the image combination module is further used for, when the zooming strategy module judges that the same first scale/the same second scale is required to be used, setting the zoomed valid region and the zoomed invalid region according to position information of the valid region and the invalid region in the original image that is recorded by the region determination module.

12. The system for zooming different regions in an image at different scales according to claim 11, wherein the zooming strategy module is further used for zooming the valid regions by using the same first scale if judging that keeping relative size of the valid regions is needed.
